(19) United States
(12) Patent Application Publication
(10) Pub. No.: US 2002/0195896 A1
(43) Pub. Date: Dec. 26, 2002

(54) D.C. brushless voice-coil motor

(76) Inventor: Chien-Chung Sun, Taipei (TW)

Correspondence Address: BIRCH STEWART KOLASCH & BIRCH, PO BOX 747, FALLS CHURCH, VA, 22040-0747, US

(21) Appl. No.: 09/884,957

(22) Filed: Jun. 21, 2001

(51) Int. Cl. H02K 21/12

(52) U.S. Cl. 310/156.32

(57) ABSTRACT

A D.C. brushless voice-coil motor is a miniature motor with a very small dimension. It has conduction coils to serve as the stator of the motor and a magnetic element which has a plurality of magnetic poles located at the same plane to serve as the rotor to simplify the components needed in the motor for achieving the miniaturization requirements. The motor includes at least a circuit board, at least two conduction coils and a magnetic element. The induction coils are located on the circuit board for generating magnetic force when receiving electric power and function as the stator of the motor. The magnetic element is located above the induction coils and has a plurality of co-plane magnetic poles to function as the rotor of the motor. Input electric power will generate inductive magnetic field, and under the interaction between the induction coils and magnetic element, the magnetic element will generate rotational kinetic energy.

### FIELD OF THE INVENTION

This invention relates to a D.C. brushless voice-coil motor and particularly a miniature D.C brushless voice-coil motor made by changing the design of the motor stator and rotor.

### BACKGROUND OF THE INVENTION

Technological developments and innovations aim mainly at improving people's living standards and making people's lives more convenient and enjoyable. For instance, Notebook computers, Personal Digital Assistance (PDA), Mobile Phones and the like, are very helpful in data storage and management, and in one-on-one long distance communication.

With technological development and innovation, besides coming out with new products and new functions, making the products more userfriendly is also a prevailing trend. Rapid innovation and progress in communication technology in recent years has catapulted the entire society to a mobile technology era. New technological products have focused on high portability and availability, to enable users to use them wherever they go and whenever they like. Therefore, small size and light weight have become a focus of the design and development of technological products in the 21^{st} century.

To meet these size requirements, the simplest way is to reduce the size of the electronic components used in the products. However, this concept is not practical for many products. For instance, individual components may be made in a smaller size, but this will create many problems during assembly. This is a common restrictive condition when trying to miniaturize the products. Even if there are no problems in assembly, the assembly work could still be difficult and costly.

Moreover, many technological products consist mostly of electronic elements. In many products, a motor is an indispensable element. The motor is used to provide rotation power, such as that installed in a notebook computer to drive a heat dissipating fan for dispersing heat, or as a driving motor in an optical disk drive. With increasing miniaturization of such products, the motor also must be made in a smaller size. In many cases, the critical factor for product miniaturization is the ability to reduce the size of the motor. The motor is mainly used to convert electricity to mechanical power. There are a wide variety of motors. The most commonly used motor in modern technological products is the D.C. brushless motor. Refer to U.S. Pat. Nos. 5,967,763 and 6,114,785. The D.C. motors disclosed in the prior art mainly consist of a stator and a rotor. The stator generally includes electric sheets (commonly called silicon steel sheets) and coils. The main body of the stator is constructed by stacking a plurality of electric sheets together (as shown in FIG. 1, U.S. Pat. No. 5,967,763). The electric sheets are wound by coils to form magnetic poles. The rotor is generally constructed by a plurality of permanent magnets, which surround the outer side of the electric sheets. When electric current flows through the coils, the coils energize the electric sheets to generate magnetic force, which produces a repulsion action against the permanent magnets. As the rotor and stator are constructed in a constant manner, the rotor will be driven to produce rotation.

Based on the design concept of miniaturization, the conventional D.C. brushless motors have the following problems:

1. The stator is made of a plurality of electric sheets that are of a definite volume. Hence the thickness of the motor cannot be reduced.

2. The magnetic repulsion direction between the stator and rotor is radial. The rotor surrounds the stator on its outer side. Hence, the radial dimension of the motor also cannot be reduced.

3. The rotor is constructed by a plurality of permanent magnets. Such a structure increases the number of components. The permanent magnets are also of a definite volume, and become a limitation for reducing the size of the motor.

Conventional D.C. motors are mostly constructed based on the design set forth above. Trying to design a miniature motor by reducing the size of the components is not possible. For instance, the stator and rotor use magnetic force repulsion to generate rotation, and the segmentation of the magnetic zones should be very clear to avoid magnetic interference, which might make the motor nonfunctional. The rotor consists of a plurality of permanent magnets, and in order to maintain the required level of magnetic force, the permanent magnets must have certain dimensions. If the dimensions of the motor are reduced, the interval between the permanent magnets must also be reduced. This might cause magnetic interference and also make the motor nonfunctional.

Moreover, based on the consideration of motor operational power, the stator of the conventional motors employs electric sheets as magnetic poles. For electrical efficiency, the electric sheets in the circuits are of a resistant material. A portion of the input electric energy will be consumed when passing through the electric sheets, thus resulting in a decrease of the motor's operational efficiency.

### SUMMARY OF THE INVENTION

In view of aforesaid disadvantages, the primary object of this invention is to provide a miniaturized D.C. brushless voice-coil motor.

The D.C. brushless voice-coil motor according to this invention mainly comprises a circuit board, two or more induction coils, a magnetic element, a rotary element, a controller and two or more magnetic pins. The induction coils are winding radially and are disposed on the circuit board and are electrically connected to the power supply input port of the circuit board. The magnetic pins are located between two induction coils. The magnetic element is located above the induction coils and is a permanent magnet which has a plurality of co-plane magnetic poles. The rotary element adheres to the magnetic element. The controller is located on the circuit board between the two induction coils for changing the magnetic characteristics of the induction coils to control the activation of the motor. When an external electric power supply flows through the induction coils, the induction coils will generate magnetic force, the magnetic pins will upset the static balance of the magnetic field in the motor, and the induction coils and magnetic element will have magnetic interaction to enable the magnetic element generating rotational kinetic energy to drive the rotary element rotating.

The induction coils of this invention serve as the stator of the motor. Hence there is no need for electric sheets. With the omission of this element, the motor dimension can be greatly shrunk. The absence of the electric sheets in the electric circuit and the void of resistance also greatly increase the motor operation power.

The magnetic element of this invention serves as the rotor of the motor. The magnetic element is a permanent magnet and includes a plurality of separated magnetic poles laid on the same plane. The magnetic line of force is in the axial direction. The induction coils are wound in the radial direction. According to Ampere's right-hand rule, the magnetic line of force of the induction coils is in the axial direction. With the magnetic element locating above the induction coils, the magnetic repulsion between the stator and rotor is in the axial direction. Under such conditions, the radial dimension of the motor can be shrunk to a smaller size.

The magnetic element of this invention includes a plurality of separated magnetic poles disposed on the same plane with the magnetic line of force in the axial direction. The magnetic poles are separated precisely and will not produce magnetic field interference therebetween even under the miniaturized conditions.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is an exploded view of this invention.

FIG. 2 is a perspective view of this invention.

FIG. 3 is a sectional view of this invention.

FIG. 4 is a schematic view of the magnetic poles of the magnetic element.

FIG. 5 is a schematic view of the main electric circuit of this invention.

### DESCRIPTION OF THE PREFERRED EMBODIMENT

This invention aims at shrinking conventional D.C. brushless motors to become miniaturized motors.

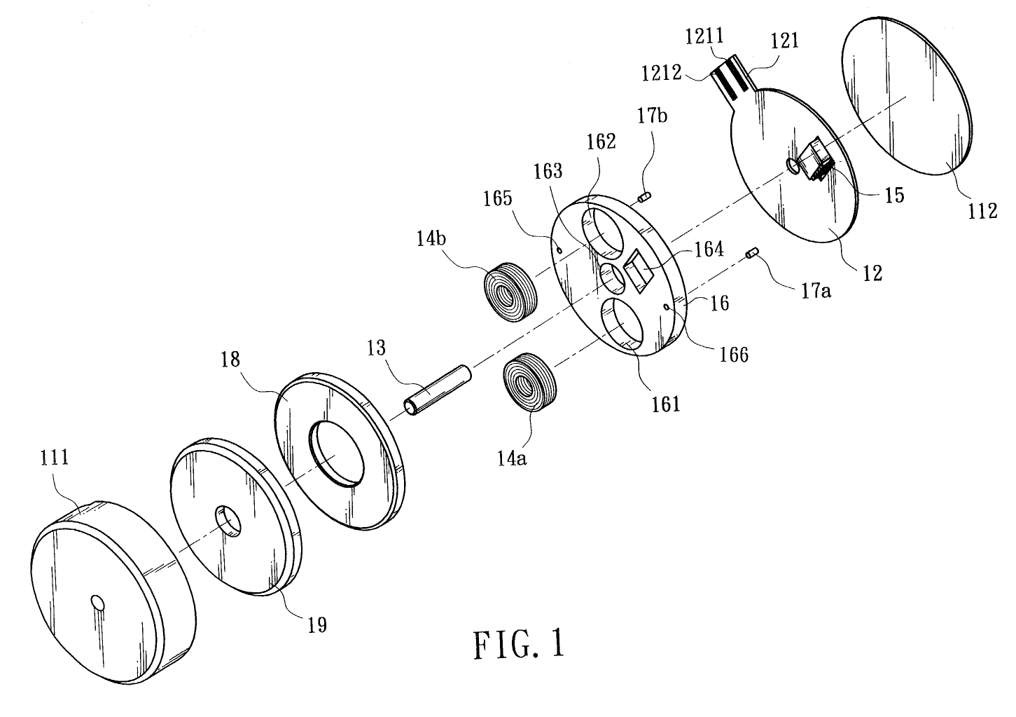

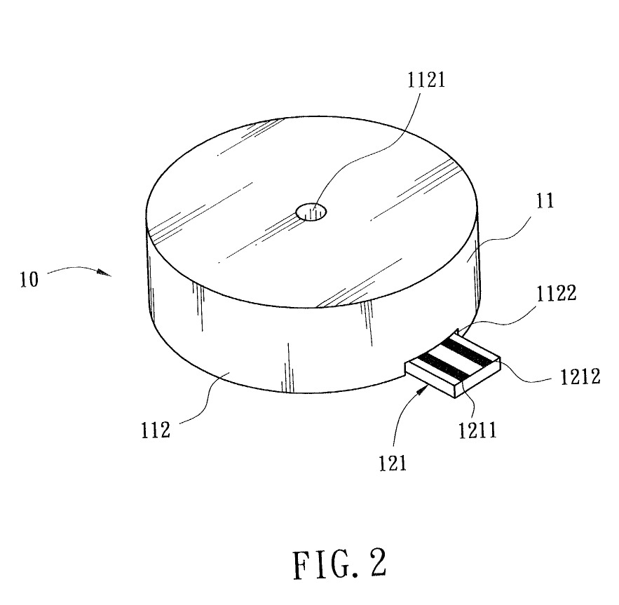

Referring to FIGS. 1 and 2, the D.C. brushless voice-coil motor 10 according to this invention mainly comprises a casing 11, a circuit board 12, a spindle 13, two induction coils 14a and 14b, a controller 15, a guard ring 16, two magnetic pins 17a and 17b, a magnetic element 18 and a rotary element 19. The casing 11 is to encase all other components of the D.C. brushless voice-coil motor 10. It is a circular body with a relatively short height and consists of a base plate 111 and an upper cap 112. As the motor 10 is to transform electric energy to magnetic energy and to convert to mechanical power, the casing 11 must be made of magnetism non-conductive material, such as aluminum, nickel or the like to avoid upsetting the magnetic induction field of the motor 10. The upper cap 112 has an aperture 1121 at the center of the top wall to enable the output shaft (not shown in the drawings) of the rotary element 19 to deliver the rotation power of the motor 10. There is an opening 1122 formed on the side wall at the bottom end of the upper cap 112.

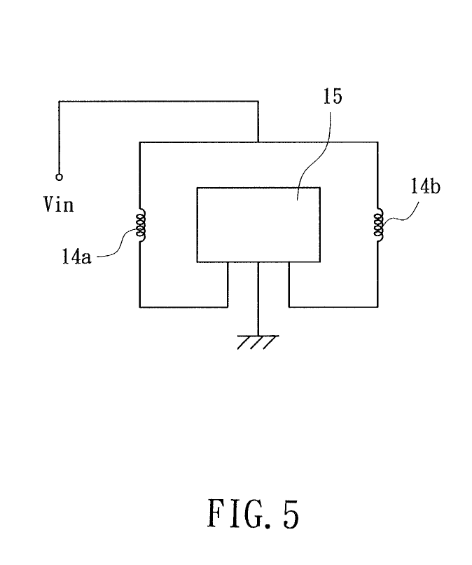

The circuit board 12, spindle 13, induction coils 14a and 14b, controller 15, guard ring 16, two magnetic pins 17a and 17b, magnetic element 18 and rotary element 19 are located sequentially from the bottom to the top inside the casing 11. The circuit board 12 is a printed circuit board which has a printed circuit located thereon. As most of the required electric characteristics of the D.C. brushless voice-coil motor 10 of this invention (such as changing current direction, activating magnetic field and the like) are built in the controller 15, the circuit design and construction of the printed circuit is not very complicated (referring to FIG. 5 for an example of the main circuitry). Hence the production cost can be reduced. In order to be housed in the casing 11, the circuit board 12 is formed in a circular shape with an electric connection port 121 extended at one side. The electric connection port 121 has power supply input contacts 1211 and 1212 located thereon for connecting an external electric power supply (not shown in the drawings) to provide electric power needed for the motor 10. The electric connection port 121 may be extended outside the casing 11 through the opening 1122 formed on the side wall of the upper case 112 for connecting the external power supply. The spindle 13 is disposed at the center of the circuit board 12.

The two induction coils 14a and 14b are made of conductive wires winding in the radial direction. They are located on the circuit board 12 and connect to the printed circuit of the circuit board 12 (shown in FIG. 5) for serving as the stator of the motor 10. According to Ampere's right-hand rule, when the electric current direction is radial and the magnetic field direction is axial, the electric current flows through the induction coils 14a and 14b will generate a magnetic field in the axial direction.

The controller 15 is a microprocessor IC mounted on the circuit board 12 and connects to the printed circuit of the circuit board 12 (as shown in FIG. 5). The controller 15 includes circuits which contain and integrate most of the electric characteristics required for driving the D.C. brushless voice-coil motor 10 (such as changing current direction, activating magnetic field and the like) thereby to activate the motor 10 to rotate as desired. By means of such a design and construction, the electronic components of the circuits in the motor 10 and the printed circuit of the circuit board 12 may be simplified. This will help the assembly work of the motor 10 and decrease the assembly cost of miniaturization.

The guard ring 16 is made of magnetism non-conductive material such as plastics to avoid upsetting the magnetic field of the motor 10. It has a first bore 161 and a second bore 162 mating the induction coils 14a and 14b, a third bore 163 located at the center mating the spindle 13, a fourth bore 164 mating the controller 15, and a fifth bore 165 and a sixth bore 166 located between the first and second bore 161 and 162. The guard ring 16 has same thickness as the induction coils 14a and 14b do. The first and second bore 161 and 162 have an inside diameter same as the outside diameter of the induction coils 14a and 14b. The guard ring 16 is disposed on the top of the circuit board 12. The spindle 13 runs through the third bore 163, and the induction coils 14a and 14b are located respectively in the first and second bore 161 and 162. The controller 15 is located in the fourth bore 164. Through coupling the first and second bore 161 and 162 with the induction coils 14a and 14b, the induction coils 14a and 14b may be maintained at the winding state. The fifth and sixth bore 165 and 166 are for engaging with the magnetic pins 17a and 17b.

The magnetic pins 17a and 17b are made of ferromagnetic material such as ferrite iron and are formed in cylindrical shapes for engaging with the fifth and sixth bore 165 and 166.

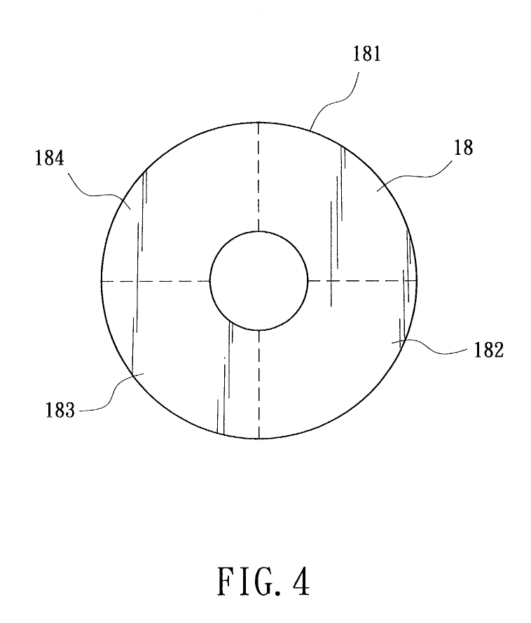

The magnetic element 18 is circular and is a permanent magnet. It is formed in an annular shape and has a plane divided into a plurality of magnetic poles 181, 182, 183 and 184 (as shown in FIG. 4) for serving as the rotor of the motor 10. The adjacent magnetic poles have different magnetic polarity (N polarity and S polarity). The magnetic line of force of the magnetic poles 181, 182, 183 and 184 are in the axial direction and will generate reaction on the induction coils 14a and 14b. When the induction coils 14a and 14b generate magnetic force, the magnetic element 18 and the induction coils 14a and 14b will have magnetic repulsion taking place between them thereby to generate rotational kinetic energy.

The rotary element 19 is made of magnetism conductive material, and is attracted to the top side of the magnetic element 18 and may rotate with the magnetic element 18 when the magnetic element 18 rotates. The rotary element 19 has an output shaft (not shown in the drawings) disposed thereon. The output shaft runs through the aperture 1121 to extend outside the upper cap 112 for delivering the rotation power of the motor 10.

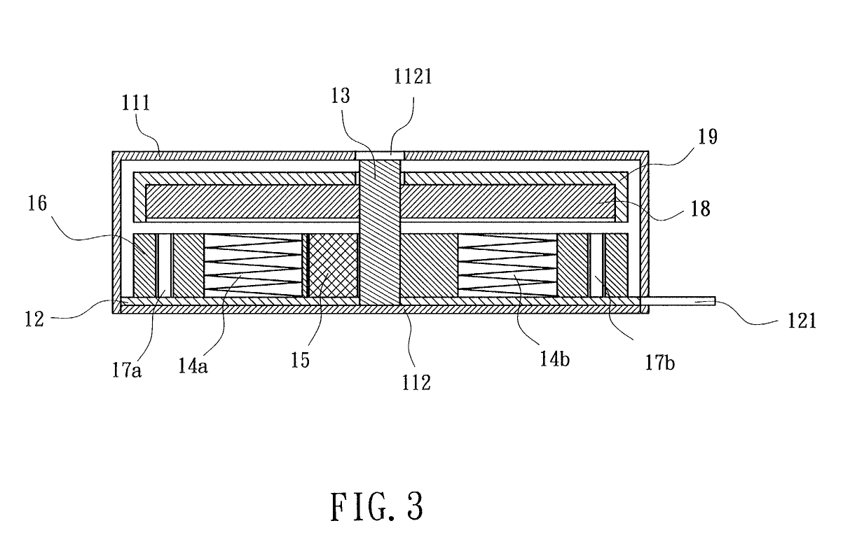

Referring to FIGS. 3 and 5, when external power supply connects to the power supply input contacts 1211 and 1212, electric power forms an electric loop through the electric connecting induction coils 14a, 14b and controller 15. The magnetic element 18 and magnetic pins 17a and 17b form a magnetic contact to make the magnetic pins 17a and 17b become temporary magnets. When the external electric power supply supplies electricity through the power supply input contacts 1211 and 1212, electric current flows through the induction coils 14a and 14b to generate magnetic force. The magnetic pins 17a and 17b upset the static balance of the magnetic field under the normal condition, the induction coils 14a,14b and the magnetic element 18 will generate repulsion between them thereby to enable the magnetic element 18 generating rotational kinetic energy.

By means of the design set forth above, and through changing the structure of the stator and rotor, the D.C. brushless voice-coil motor of this invention may be made in a miniature size.

Furthermore, the miniature motor of this invention may attain high rotation speed. Moreover, because of the induction coils are used to replace traditional stator, the problems incurred by using electric sheets for stator may be avoided. It also saves costs and improves electric characteristics.

In addition, in the motor of this invention, the magnetic repulsion between the stator and rotor is at the axial direction. It is different from the conventional motors which have magnetic repulsion between the stator and rotor in the radial direction.

Experimental results indicate that the rotation speed of the motor of this invention can reach 10,000-30,000 rpm or above. The total circular disk of the rotor mounted on the base plate has a diameter about 1-1.5 cm. Overall operation result is excellent. After achieving the object of miniaturization, the motor still produces desired or better efficiency.

While the preferred embodiment of this invention has been set forth for purpose of disclosure, modifications of the disclosed embodiments of the invention as well as other embodiment thereof may occur to those skilled in the art. Accordingly, the appended claims are intended to cover all embodiments which do not depart from the spirit and scope of this invention.

What is claimed is:

1. A D.C. brushless voice-coil motor, comprising:
a circuit board having printed circuits located thereon and at least two electric power supply input contacts;
at least two induction coils wound radially and located on the circuit board;
a magnetic element having a plurality of magnetic poles arranged in a co-plane fashion and being disposed above the induction coils;
at least two magnetic pins being magnetism conductive and located between the circuit board and the magnetic element, and also being disposed between the induction coils, and becoming magnetized when contact the magnetic element; and
a controller located on the circuit board and connected electrically to the induction coils for activating the induction coils to form magnetic poles;
wherein the induction coils generate magnetism to become magnetic poles to repulse the magnetic element when electric current flows through the induction coils thereby enabling the magnetic element to generate rotational kinetic energy.

2. The D.C. brushless voice-coil motor of claim 1 further having a casing made of a material which is magnetism non-conductive.

3. The D.C. brushless voice-coil motor of claim 2, wherein the casing includes a base plate and an upper cap.

4. The D.C. brushless voice-coil motor of claim 3, wherein the upper cap has an aperture formed at the center of a top wall thereof and an opening located on a side wall at the bottom end thereof.

5. The D.C. brushless voice-coil motor of claim 1, wherein the circuit board has a spindle disposed at the center thereof.

6. The D.C. brushless voice-coil motor of claim 1 further having a guard ring located between the circuit board and the magnetic element.

7. The D.C. brushless voice-coil motor of claim 6, wherein the guard ring is made of a material which is magnetism non-conductive.

8. The D.C. brushless voice-coil motor of claim 6, wherein the guard ring further has a first bore and a second bore for holding the induction coils, a third bore for holding the spindle, a fourth bore for holding the controller, and a fifth bore and a sixth bore for holding the magnetic pins.

9. The D.C. brushless voice-coil motor of claim 1, wherein the circuit board has an electric connection port extended outwards through the opening of the casing, the electric connection port having electric power supply input contacts located thereon.

10. The D.C. brushless voice-coil motor of claim 1, wherein the magnetic force direction of the induction coils is axial.

11. The D.C. brushless voice-coil motor of claim 1, wherein the magnetic force direction of the magnetic element is axial.

12. The D.C. brushless voice-coil motor of claim 1, wherein the controller is a microprocessor.

13. The D.C. brushless voice-coil motor of claim 1 further having a rotary element disposed above the magnetic element for rotating with the magnetic element to output rotational power.
